(19) United States
(12) Patent Application Publication
(10) Pub. No.: US 2017/0217527 A1
(43) Pub. Date: Aug. 3, 2017

(54) TRICYCLE

(71) Applicant: JIN CHANG SHENG INTERNATIONAL CO., LTD, Taichung (TW)

(72) Inventor: Ming-Jhang Li, Taichung (TW)

(21) Appl. No.: 15/013,819

(22) Filed: Feb. 2, 2016

(51) Int. Cl. B62K 5/08; B62K 5/06

(52) U.S. Cl. CPC B62K 5/08; B62K 5/06

(57) ABSTRACT

A tricycle includes a frame, a chair, a handle, a front wheel, two pedals, two wheel-supporting units, two rear wheels and a connector. The frame includes a longitudinal tube, a fork connected to the longitudinal tube, and a transverse tube connected to the longitudinal tube. The chair is supported on the longitudinal tube. The handle is pivotally supported on the longitudinal tube in front of the chair. The front wheel is connected to the fork. The pedals are connected to the front wheel. Each of the wheel-supporting units includes a threaded shaft inserted through the transverse tube and engaged with a nut and an axle inserted through a corresponding one of the rear wheels. The threaded shaft comprises an axis that does not intersect the axle. The connector connects the handle to one of the wheel-supporting units.

### BACKGROUND OF INVENTION

1. Field of Invention

The present invention relates to a tricycle and, more particularly, to an inexpensive tricycle that includes only one directly steered rear wheel and a free rear wheel.

2. Related Prior Art

As disclosed in Taiwanese Patent Nos. M364645 and M366500, a tricycle includes a frame for supporting a front wheel and two rear wheels. The typical tricycle further includes a steering mechanism that includes a handlebar and two linkage units. Each of the linkage units connects a corresponding one of the rear wheels to the handlebar. However, the use of two linkage units inevitably renders the tricycle expensive.

U.S. Pat. No. 8,256,784 discloses a tricycle including a frame 102, a front wheel assembly 110, a front steering mechanism 120, two rear wheel assemblies 150 and at least one rear steering mechanism 470. The front steering mechanism 120 is adapted to steer the front wheel assembly 110. Each rear wheel assembly 150 includes a casing 151a (151b), a rear wheel 152a (152b), a rear wheel axle 153a (153b) and a coupling member 154a (154b). Each casing 151a (151b) holds a corresponding rear wheel axle 153a (153b) that supports a corresponding rear wheel 152a (152b). Each casing 151a (151b) is connected to an end 132 (134) of a crossbar 130 of the frame 102 via a corresponding coupling member 155a (155b). However, the rear casing 151a cannot smoothly follow the rear casing 151b if the rear steering mechanism 470 is only connected to the rear casing 151b since the axis of each coupling member 155a (155b) intersects the axis of the corresponding rear wheel axle 153a (153b).

The present invention is therefore intended to obviate or at least alleviate the problems encountered in prior art.

### SUMMARY OF INVENTION

It is an objective of the present invention to provide an inexpensive reliable tricycle.

To achieve the foregoing objectives, the tricycle includes a frame, a chair, a handle, a front wheel, two pedals, two wheel-supporting units, two rear wheels and a connector. The frame includes a longitudinal tube, a fork connected to the longitudinal tube, and a transverse tube connected to the longitudinal tube. The chair is supported on the longitudinal tube. The handle is pivotally supported on the longitudinal tube in front of the chair. The front wheel is connected to the fork. The pedals are connected to the front wheel. Each of the wheel-supporting units includes a threaded shaft inserted through the transverse tube and engaged with a nut and an axle inserted through a corresponding one of the rear wheels. The threaded shaft comprises an axis that does not intersect the axle. The connector connects the handle to one of the wheel-supporting units.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a tricycle according to the preferred embodiment of the present invention;

FIG. 2 is a bottom view of the tricycle shown in FIG. 1;

FIG. 3 is a side view of a rear wheel used in the tricycle shown in FIG. 1;

FIG. 4 is a bottom view of the tricycle in another orientation than shown in FIG. 2; and

FIG. 5 is a bottom view of the tricycle in another orientation than shown in FIG. 4.

### DETAILED DESCRIPTION OF PREFERRED EMBODIMENT

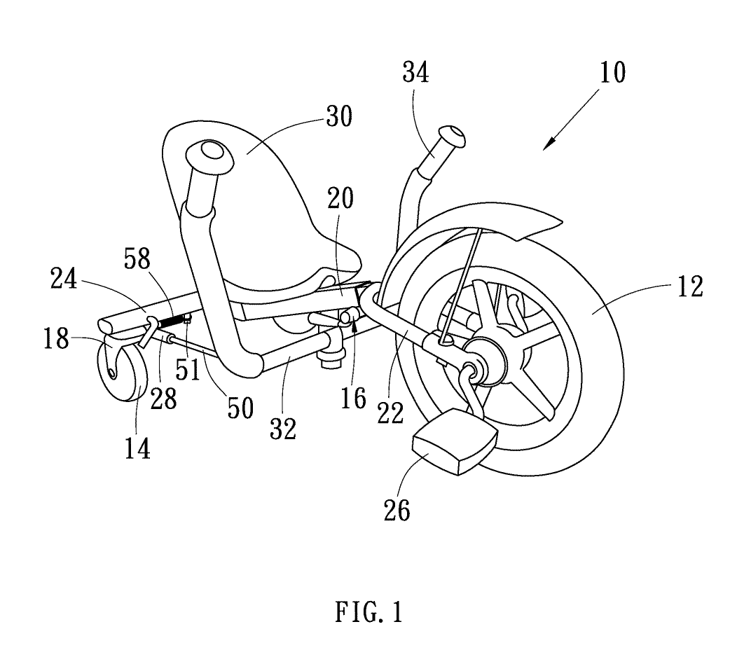

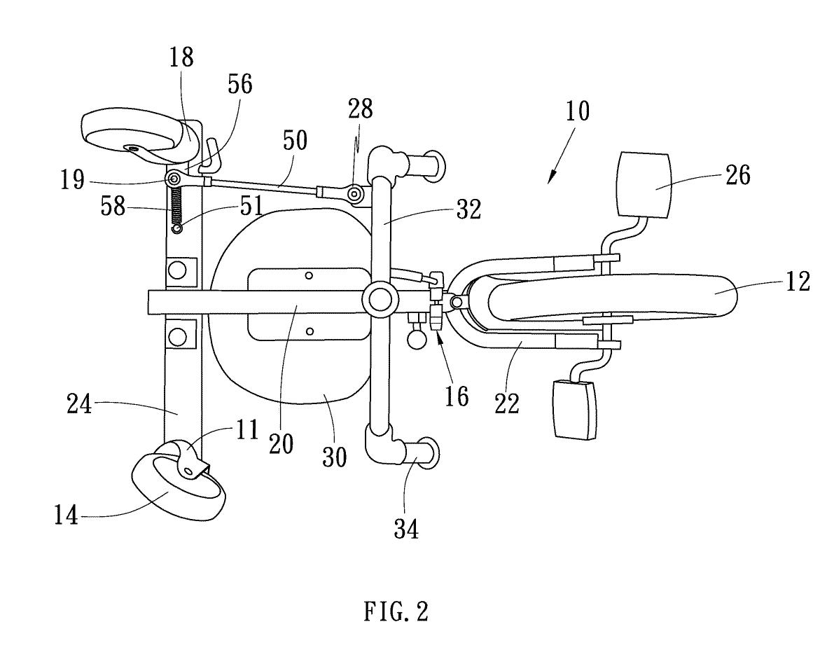

Referring to FIGS. 1 and 2, there is a tricycle 10 according to the preferred embodiment of the present invention. The tricycle 10 includes a frame (not numbered) for supporting a front wheel 12 and two rear wheels 14.

The frame is a substantially T-shaped element that includes a longitudinal tube 20 and a transverse tube 24. A rear end of the longitudinal tube 20 is connected to a middle portion of the transverse tube 24 by welding for example.

A fork 22 includes a shaft and two prongs. The shaft of the fork 22 is connected to a front end of the longitudinal tube 20 in a telescopic manner to render the effective length of the tricycle 10 adjustable. Preferably, the shaft of the fork 22 is inserted in the front end of the longitudinal tube 20. The shaft of the fork 22 is not allowed to rotate relative to the longitudinal tube 20.

An adjustor 16 is used to control the movement of the shaft of the fork 22 relative to the longitudinal tube 20. The adjustor 16 includes a pin and a quick-release device. The adjustor 16 will not be described in detail for being conventional.

The front wheel 12 is connected to the prongs of the fork 22 by a crank shaft (not numbered) that includes two cranks (not numbered). Each of the cranks is connected to a pedal 26. The pedals 26 are trodden to move the tricycle 10. The front wheel 12 cannot be steered because the shaft of the fork 22 is not allowed to rotate relative the longitudinal tube 20.

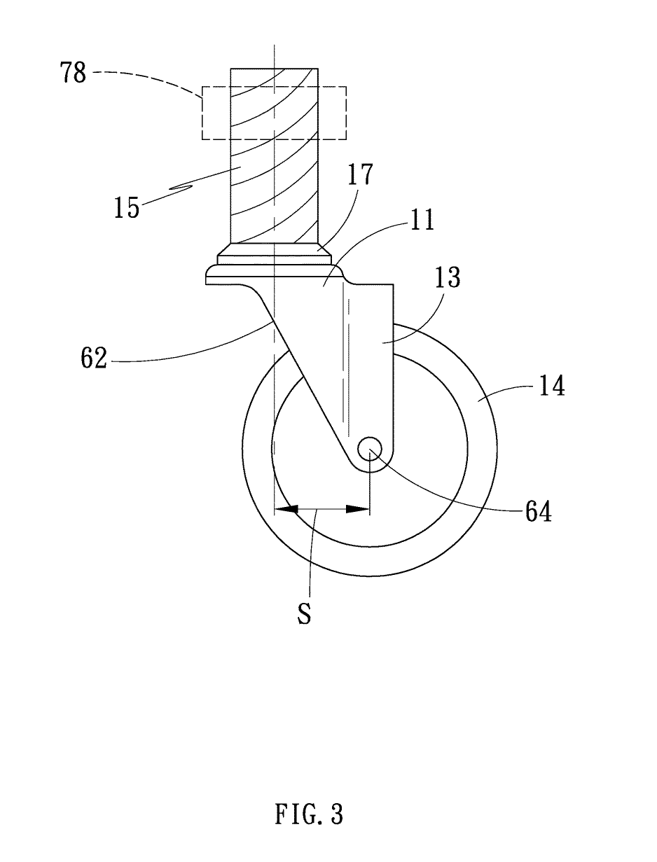

Referring to FIGS. 1 through 3, each of the wheel-supporting units 11 and 18 includes two prongs 13 and a threaded shaft 15. The threaded shaft 15 is inserted through a bearing 17 and a corresponding end of the transverse tube 24 before it is engaged with a nut 78. Thus, the wheel-supporting units 11 and 18 are rotationally connected to the transverse tube 24. Each of the rear wheels 14 is connected to the prongs 13 of a corresponding one of the wheel-supporting units 11 and 18 by an axle 64. The axle 64 is separated from an axis 62 of the threaded shaft 15 by a distance S to facilitate steering of each rear wheel 14 about the axis 62 of the threaded shaft 15.

The primary wheel-supporting unit 18 further includes a lever 56 connected to one of the prongs 13 thereof by welding for example. A fastener 19 such as a screw is connected to an end of the lever 56. A connector 50 includes an end connected to the fastener 19 by a universal joint 28 and another end connected to the handle 32 by another universal joint 28. A tension spring 58 includes an end connected to the fastener 19 and another end connected to a rod 51 connected to the transverse tube 24 by welding for example. The tension spring 58 tends to return the primary wheel-supporting unit 18 to an original orientation so that the tricycle 10 moves straightly forwards.

A handle 32 is rotationally connected to the longitudinal tube 20. The handle 32 includes a middle portion rotationally connected to the longitudinal tube 20 and two ends each inserted in a tubular grip 34.

A chair 30 is supported on a portion of the longitudinal tube 20 behind the handle 32. As mentioned above, the effective length of the tricycle 10 is adjustable. Therefore, a user, tall or short, can tread the pedals 26 while sitting in the chair 30.

The tricycle 10 should be equipped with a braking system although such a braking system is not shown. Such a braking system includes at least one lever provided near one of the grips 34, a caliber supported on the fork 22, two brake shoes supported on the caliber, and a cable for connecting the lever to the caliber.

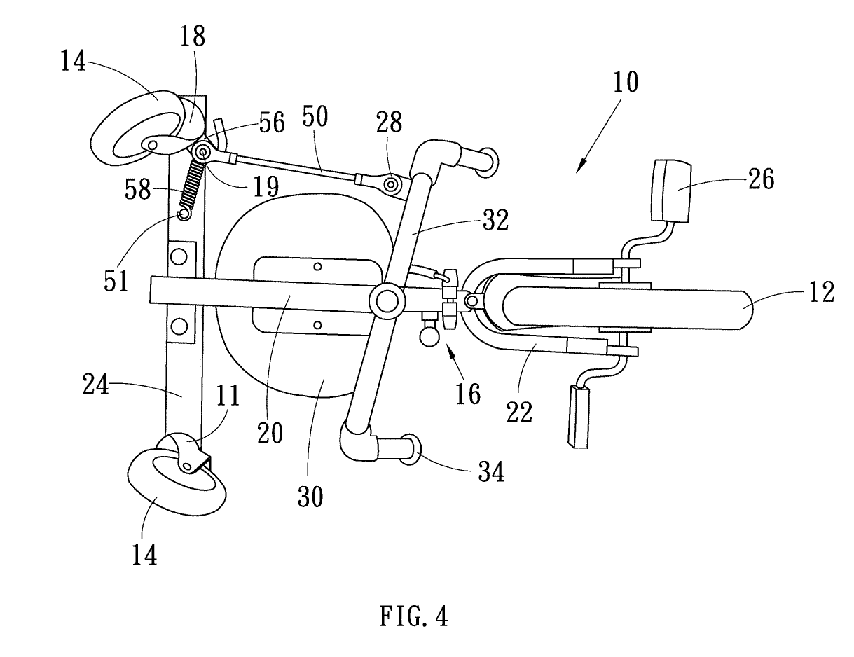

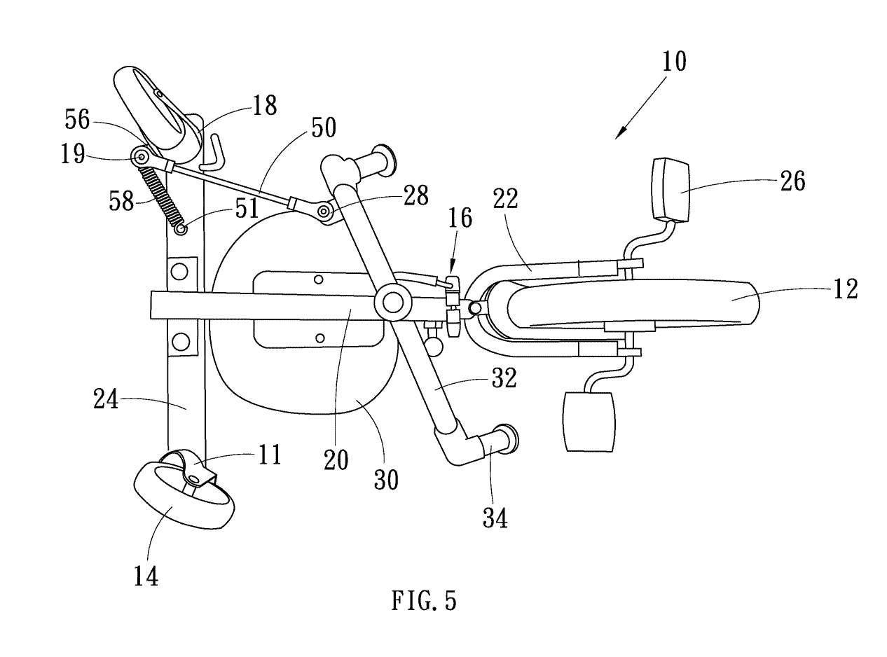

Referring to FIG. 4, the handle 32 is pivoted clockwise. Via the connector 50, the handle 32 pulls and hence pivots the primary wheel-supporting unit 18 and the corresponding rear wheel 14 in a direction. The tricycle 10 is steered to the right. Referring to FIG. 5, the handle 32 is pivoted counterclockwise. Via the connector 50, the handle 32 pushes and hence pivots the primary wheel-supporting unit 18 and the corresponding rear wheel 14 in another direction. The tricycle 10 is steered to the left.

The secondary wheel-supporting unit 11 is quickly pivoted from any orientation to an orientation substantially parallel to that of the primary wheel-supporting unit 18 regardless of the orientation of the primary wheel-supporting unit 18 as long as the wheels 14 are rolling on the ground. The tension spring 58 is loaded, ready for returning the primary wheel-supporting unit 18 to the original orientation.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A tricycle comprising:
a frame comprising a longitudinal tube, a fork connected to the longitudinal tube, and a transverse tube connected to the longitudinal tube;
a front wheel connected to the fork;
two pedals connected to the front wheel;
two wheels;
a chair supported on the longitudinal tube;
a handle pivotally supported on the longitudinal tube in front of the chair;
two wheel-supporting units each comprising a threaded shaft inserted through the transverse tube and engaged with a nut and an axle inserted through a corresponding one of the rear wheels, wherein the threaded shaft comprises an axis that does not intersect the axle; and
a connector for connecting the handle to one of the wheel-supporting units.

2. The tricycle according to claim 1, further comprising a universal joint arranged between the connector and the handle.

3. The tricycle according to claim 1, further comprising a universal joint arranged between the connector and one of the wheel-supporting units.

4. The tricycle according to claim 2, wherein one of the wheel-supporting units comprises a lever connected to the universal joint.

5. The tricycle according to claim 3, further comprising a tension spring for connecting the lever to the transverse tube.

6. The tricycle according to claim 4, further comprising fastener for connecting the tension spring to the lever.

7. The tricycle according to claim 4, wherein the transverse tube further comprises a stake connected to the tension spring.

8. The tricycle according to claim 1, further comprising two grips connected to the handle.
